(19) United States
(12) Patent Application Publication
(10) Pub. No.: US 2004/0133455 A1
(43) Pub. Date: Jul. 8, 2004

(54) System and method for glucose monitoring

(76) Inventor: Kevin Lee McMahon, Dallas, TX (US)

Correspondence Address: James J. Murphy, Winstead Sechrest & Minick P.C., 400 North Ervay Street, P.O. Box 50784, Dallas, TX, 75201, US

(21) Appl. No.: 10/741,967

(22) Filed: Dec. 19, 2003

Related U.S. Application Data
(60) Provisional application No. 60/435,017, filed on Dec. 19, 2002.

(51) Int. Cl. G06F 17/60

(52) U.S. Cl. 705/3; 600/300

(57) ABSTRACT

A novel remote monitoring, command and control system for enabling real-time disease management that includes a mobile wireless device which in one embodiment of the invention doubles as and replaces an existing tool within the patients' regimen so as to become a transparent tool within the list of paraphernalia relied upon by chronically afflicted patients and their extended team of caregivers. In the preferred embodiment, the device consists of a case with enclosures and is of a portable nature so as to accompany an individual easily. In another embodiment, the device simply enhances the remote connection to any wide area network for providing the capabilities of the system. Additionally, the system incorporates specialized analysis tools to facilitate any number of dynamic peer group comparisons in order to facilitate the easy and productive analysis across any sized population of inclusive patients with the data coming from any number of third party data management applications, logs, or other sources. Additionally, the platform is positioned as an open platform to facilitate the testing and utilization of an infinite number of third party predictive algorithms that can be used to improve the feedback of qualified recommendations to the patient for modifications in their actual or prescribed disease management protocol.

### CROSS-REFERENCE TO RELATED APPLICATION

This application claims priority to U.S. Provisional Application Serial No. 60/435,017 filed on Dec. 19, 2002 by inventor Kevin Lee McMahon, currently pending.

### FIELD OF INVENTION

The present invention generally relates to a system and method for obtaining data from external as well as implanted biometric and drug delivery devices including glucometers, insulin pumps, pedometers, accelerometers and other data-enabled instruments relevant to the care of diabetes, and transmitting such data from remote locations providing a highly accurate progression of the patient's glucose, exercise, insulin, carbohydrate intake and other levels for more effective medical treatment.

### BACKGROUND OF THE INVENTION

Affecting as many as 16 million Americans, diabetes is characterized by abnormal levels of sugar in the bloodstream, resulting from defects in insulin production and/or insulin action. A degenerative condition, diabetes causes sugar to build up in your blood and can lead to serious health complications such as heart disease, blindness, stroke, kidney failure and limb amputation.

A healthy diet is just as important as taking insulin or glucose tablets. A low fat, low sugar diet containing plenty of starchy foods and fruit and vegetables helps to stabilize blood fat and blood glucose levels and control weight.

Low-income individuals are the most at-risk group suffering from Type 2 diabetes. One American study, for example, discovered that among low-income earners, 16.1 percent of men and 21.1 percent of women had diabetes, compared to 6.2 percent and 4.0 percent respectively among upper income earners. American Indians had the highest incidences in the world—47.6 percent of men and 48.9 percent of women.

Blood sugar testing is an integral part of diabetes management. Testing helps patients monitor diabetes and make adjustments in their diet and exercise regimen as needed. The goal is to keep blood sugar levels as close to normal as possible. In doing so, the patient can delay or even prevent many long-term health problems caused by consistently high (hyperglycemia), low (hypoglycemia) and the wide swings in blood sugar levels.

In the past, a diabetic patient who needs to monitor and control blood glucose levels typically carried the following paraphernalia: (1) a supply of disposable lancets, (2) a reusable lancing device which accepts the lancets, (3) an electronic glucose meter (glucometer), (4) a supply of disposable glucose test strips for the meter, and (5) tools for insulin injection (insulin, disposable hypodermic needles, and a syringe). The patient typically carries these items in the form of a kit, which may also contain (6) a variety of control and calibration strips to assure the accuracy of the meter and the measurement.

After blood has been transferred to the test strip, the glucose meter then measures the blood glucose concentration (typically by chemical reaction of glucose with reagents on the test strip). Such blood glucose measurements permit the diabetic to manage his glucose levels, whether that is to inject a corresponding dose of insulin (generally Type I diabetic) or using a protocol established with his physician to modify his diet and exercise (Type I or Type II diabetic). Used lancets and test strips are removed and discarded (or kept for subsequent disposal in a hazardous waste container kept elsewhere). Any extra blood is cleaned from the equipment and the wound site, and all pieces of apparatus are stored for future use. The entire process usually takes a few minutes.

From this point, patients have some form of agreement with their diabetes team as to logging and periodic communication of the glucose readings, insulin dosing, and other comments pertinent to the diabetes management regimen. These handwritten “logs” are then faxed to the endocrinology staff or brought with them to their semi-annual or quarterly status checkups with their endocrinologist.

Most patients, however, fail to adequately log and communicate this data, if they keep a log at all, until a critical moment is at hand. Examples of these situations are calling in to get direction regarding “out of control” blood sugar levels or in the doctor's office during the quarterly check up. This need for information is a bottleneck to effective diagnosis and prescription. Even when used, these personal logs are lacking in their precision, timeliness, and sometimes readability, which can make the task of diagnosis and prescribing of changes to the standing protocol difficult.

There have been several attempts to close these gaps in communication and self-management using technologies which include handheld computers, desktop personal computers (“PCs”), internet connectivity, web-based applications, and specialized glucometers that physically integrate with Personal Data Assistants (“PDAs”).

For example, U.S. Pat. No. 5,899,855, issued on May 4, 1999 to Stephen Brown discloses a modular self-care health monitoring system employing a compact microprocessor-based unit such as a video game system of the type that includes switches for controlling the device operation and a program cartridge. The program cartridge adapts the microprocessor-based unit for operation with a glucose monitor. The microprocessor-based unit processes data supplied by the glucose monitor to supply data on the microprocessor-based unit or separate display monitor. The system then transfers the data to a remote clearinghouse that in turn transfers the data to a healthcare professional via facsimile transmission.

Likewise, U.S. Pat. No. 6,144,922 issued on Nov. 7, 2000 issued to Douglas et al. discloses an analyze concentration information collection system and communication system. This invention is described as a two part device including a monitoring instrument and a communications module that rely on each other to generate test data and to forward to an external personal computer or via modem across the internet to an electronic bulletin board.

U.S. Pat. No. 6,427,088 issued on Jul. 30, 2002 issued to Bowman, IV et al discloses an implanted medical device (e.g. infusion pump) and an external device communicate with one another via telemetry messages that are receivable only during windows or listening periods. Each listening period is open for a prescribed period of time and is spaced from successive listening periods by an interval. The prescribed period of time is typically kept small to minimize power consumption. To increase likelihood of successful communication, the window may be forced to an open state, by use of an attention signal, in anticipation of an incoming message. To further minimize power consumption, it is desirable to minimize use of extended attention signals, which is accomplished by the transmitter maintaining an estimate of listening period start times and attempting to send messages only during listening periods. In the communication device, the estimate is updated as a result of information obtained with the reception of each message from the medical device.

### SUMMARY OF INVENTION

The inherent simplicity and low cost of the present invention is what makes it so attractive to clinicians and diabetics. Non-technical users can utilize the present invention with absolute minimal training. In addition, even in the case of the patient who only uses the health management device component of the system provides an invaluable window to the medical profession that will enable proactive patient disease management thereby contributing greatly to the reduction in healthcare costs due to unforeseen complications that are widely known and attributed to diabetes.

Additionally, the remote aspect of this invention is a critical enhancement to such things as the closed loop artificial pancreas as a link between the prior arts that emphasize only the short-range telemetry. A primary use of the invention would be long-range, remote telemetry for a remote monitoring, command and control system.

Moreover, because lifestyle has a direct relationship with the localized time of day, transitions between time zones must be managed and accounted for based on individualized algorithms to determine the transition plan between testing, dosing, carbohydrate intake, exercise, etc. The prior art technologies fail to automate time management and synchronize standards of time as it relates to delivery system scheduling and data marking. The present invention relies on external standards of time to account for the impact of patient mobility, in this case, as it relates to societal imposed standards of time (e.g. Greenwich International Time Zones). This aspect of data cleansing is especially important with a disease such as diabetes due to the direct relationship with meals and carbohydrate intake as well as sleep and exercise.

Further, the present invention enables the development, testing and invocation of various predictive algorithms used for identifying optimizations within the prescribed protocol or new prescriptions. The system may be used to automate the analysis, notification, recommendation, authorization and implementation of the recommended changes in a secure, controlled automated feedback loop system for chronic disease management. Due to the critical nature of the established protocol and the dependence on technology and imperfect techniques and systems, a remote monitoring, command and control approach is essential to the safeguarding of the individuals utilizing aspects of standard disease management systems. This becomes especially important as advancements in technology bring about the experimentation and deployment of expert systems but with only localized monitoring, command and control systems. The inventions described herein attempt to address this critical limitations of the prior art.

Integrating low cost wireless devices using passive data collection methods into the practice of healthcare will add value by helping to overcome the dependencies on human intervention to record and share information in a timely fashion. This will ultimately help to decrease costs, increase efficiency and provide peace of mind during times of separation between those with actual or perceived responsibility for other's care and the chronically diseased patient. These mobile computing devices will transform data into timely, valuable information previously only available at the point-of-care.

The foregoing outlined some of the more pertinent features of the present invention. One should construe these features as merely illustrative of some of the more prominent features and applications of the invention. One may obtain many other beneficial results when applying the disclosed invention in a different manner or modifying the invention as described. Accordingly, one may recognize other features and a fuller understanding of the invention when referring to the following Detailed Description of the Preferred Embodiment.

### BRIEF DESCRIPTION OF DRAWINGS

For a more complete understanding of the present invention, and the advantages thereof, reference is now made to the following descriptions taken in conjunction with the accompanying drawings, in which like reference numerals refer to identical or functionally-similar elements throughout the separate views and which are incorporated in and form part of the specification:

FIG. 1A depicts an example of a medical apparatus of the present invention utilizing a single microprocessor to perform both the intelligent device polling logic as well as the communications function.

FIG. 1B is a high level functional block diagram of a representative network-based system embodying the principles of the present invention.

FIG. 2 depicts an example of a medical apparatus of the present invention utilizing a second microprocessor to perform the intelligent device polling logic whereas the third party communications processor has only that primary function and thereby relies on the second microprocessor to perform complex processing routines.

FIG. 3 depicts an example of a medical apparatus of the present invention utilizing a second microprocessor to perform the intelligent device polling logic whereas the third party communications processor has only that primary function and thereby relies on the second microprocessor to perform complex processing routines. In addition, this configuration addresses advanced data management techniques and enables premium interactive services via the introduction of a user interface and data input mechanism.

FIG. 4 depicts an example of a medical apparatus of the present invention utilizing a second microprocessor to perform the intelligent device polling logic whereas the third party communications processor has only that primary function and thereby relies on the second microprocessor to perform complex processing routines. In addition, this configuration addresses advanced data management techniques and enables premium interactive services via the introduction of a standalone third party handheld computing device. In this configuration, the PDA is able to synchronize with the case and take advantage of its communications capabilities. Also, by using the connection point usually reserved for data synchronization as the communications port via the communications capabilities of the case, limited expansion slots in the PDA can now be simultaneously used for other peripheral device componentry such as additional memory cards, digital photography, etc. . . .

### DETAILED DESCRIPTION OF THE INVENTION

Preferred embodiments of the present invention are illustrated in the FIGURES, like numerals being used to refer to like and corresponding parts of the various drawings. The particular values and configurations discussed in these non-limiting examples, however, can be varied and are cited merely to illustrate an embodiment of the present invention and are not intended to limit the scope of the invention.

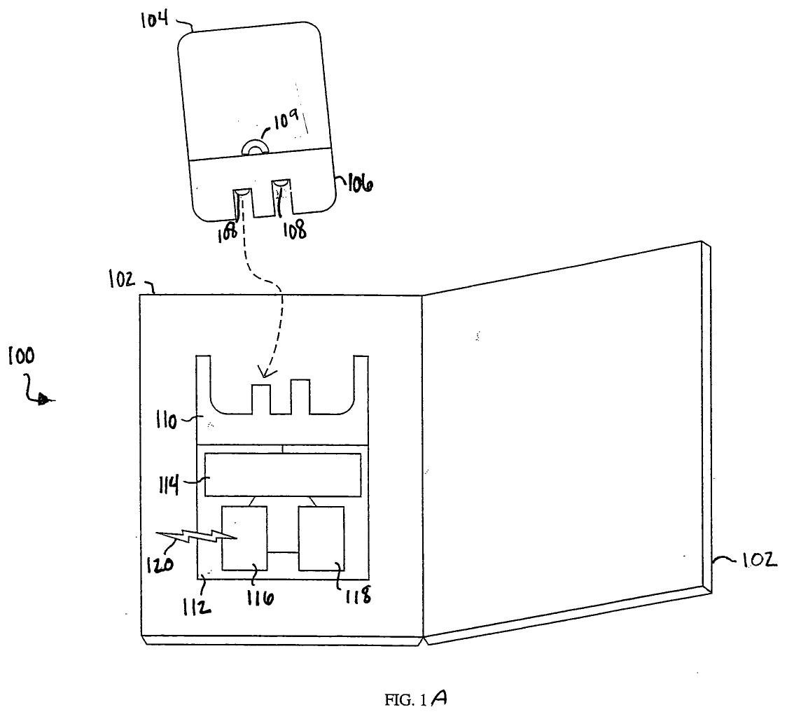

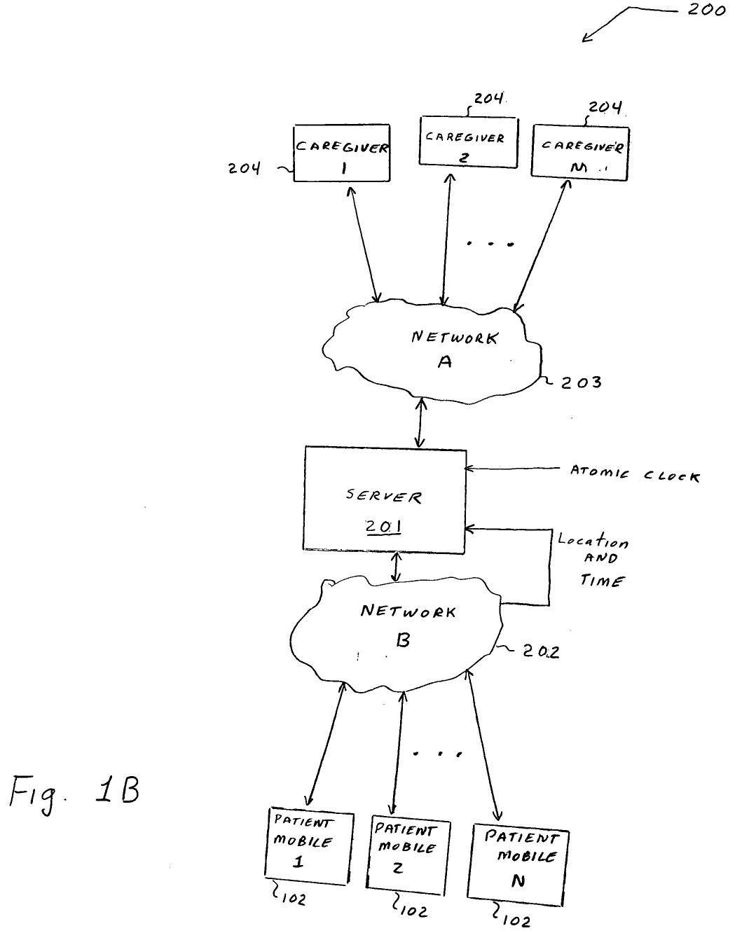

FIG. 1 depicts an example of a remote, real-time diabetes management system (mobiles) 100 including a handheld case 102 with a nexus between communications components and biometric devices that can be integrated using a two-plate configuration. A device connection plate 106, has a multitude of configurations necessary to provide for easy and logical placement and storage of an individuals data-enabled disease management tools. Specifically, device connection plate 106 provides a hardwired interface between a selected biometric device 102 and a corresponding plate 110. These devices are situated in such a way so as to simultaneously invoke polling of biometric device 102 via a completed physical connection at the same time that they are replaced into their dedicated home within health management case 102. For example, in the case of diabetes, biometric device 102 is a glucometer, which can come in different sizes and different data-port locations and interface technologies (e.g. stereo-plug connectors, infra-red, optical recognition, wireless, audio recognition, etc. . . . ). Connection plate 104 provides connections 108 which wire to the specific terminals of biometric device 102 and also mate with plate 110, such that a physical and electrical interface between biometric device 102 and management systems 100 is supported. Likewise, the inventory of biometric devices 102 varies greatly by patient thus creating a multitude of patient-specific device storage options that may include, among other things: glucometers; insulin pumps and/or other insulin injection devices; pedometers and/or other exercise/activity measuring devices including accelerometers; and thermometers and/or other temperature sensing devices.

FIG. 1B is a high level functional block diagram of a representative network-based system 200 embodying the principles of the present invention. System 200 is centered around a server 201 operated by either a public or a private entity. In addition to providing overall system control, server 201 receives and collects biometric information from a corresponding set of N number of patient mobile (management) units 100, three of which are shown in FIG. 1B for reference. The biometric information generated by patient mobiles 100 is transmitted by server 201 through a network 202, which is preferably a wireless network, although network 202 could also be a combination of wireless and hardwired network components. In the illustrated embodiment, patient mobiles 102 transmit via a wireless link to network 202 for further transmission to server 201. In a fully wireless environment, network 202 is a wireless wide area network supported by a commercial provider, such as Skytel, Weblink Wireless, or the like. Alternatively, network 202 may include access points, such as IEEE 802.11x access points which receive wireless data from patient mobiles 102 in the area of given access points and subsequently transfer the associated biometric data to server 201 via a hardwired connection.

Biometric data collected by server 201 from patient mobile units 102 is distributed to one or more of M number of care givers 204 through network 203. Network 203 is preferably a hardwired interconnection through a private network, such as a private wide area network, or a public-based network, such as the Internet or the World Wide Web. Individual care givers can then utilize their own individual automated risk-based population stratification schemes for identifying particular patients, which require particular attention. Caregivers generally include doctors, nurses, school nurses, hospitals, clinics, family members and relatives forming a team supporting the care of a corresponding patient.

Server 201 receives time and location information from each patient mobile 102, allowing the corresponding care giver 204 the ability to monitor the timeliness of the patient's testing and monitoring activities. In the illustrated embodiment, server 201 controls the system timing, in conjunction with networks 202 and 203, from a national atomic clock or similar standardized time base.

Advantageously, utilization of system 200 does not require a modification of patient behaviour. In other words, since system 200 is transparent to the individual patient, the patient need not perform any additional task, (e.g., connecting to the network, contacting the caregiver directly, etc. . . . ) other than those already prescribed by the doctor for use of the given biometric device 104. Further, system 200 supports event-based and trend-based triggers which allow healthcare providers to intervene in response to test results which cross a given threshold or tend towards a threshold. For example, a test of blood sugar below a given level may trigger a prompt (either automated, rules based, or human) to the patient (via telephone, email, etc.) to perform a retest or take other appropriate action.

Management system 100 also includes an electronics board 112 having a conventional radio-frequency (RF) transceiver 116, a microprocessor 114, responsible for managing the commands and logic of the RF transceiver 116, and a power supply 118.

Wireless connection (transmission) may occur by any number of means. However, in the preferred embodiment of the invention, a radio connection adds to the simplicity of use by removing the need to physically connect to another device in order to share information resident in the management system 100. This connection can be short range, as in the case of an IEEE 802.11x wireless connection to a wireless access point, or long range, as in the case of cellular and paging networks. In any case, the point of transmitting is to enable the sharing and distribution of data and information. Additionally, this transmission and reception capability allows for remote diagnostics of the device componentry and the electronics themselves. The role of transmitting this data is shared by a multitude of computers. The goal of transmitting this data is to facilitate timely and appropriate communication within an infinite number of public and proprietary processes.

Power supply 118 can be of any source including replaceable and rechargeable battery, solar cells, etc . . . it is simply the source of power to drive the electronics within the case and not necessarily used to drive the third party devices although that is one option.

Interface plate 109, coupled to biometric device 104, by plate 106, senses physical connections with plate 110. Integration device 109 is a part of plate 106 and universally applicable to any third party biometric device 104. This is primarily one of many mechanisms management system 100 employs that abstracts behavioral dependency from the device polling and transmission process. By placing a device or connection into plate 106, the sensor is physically affected in one or many ways to acknowledge a change in state which then invokes various device polling routines which among other things, checks for new data in third party biometric device 104. These integration sensors 109 can also be used to verify connection between the componentry of the case as a means of troubleshooting the system.

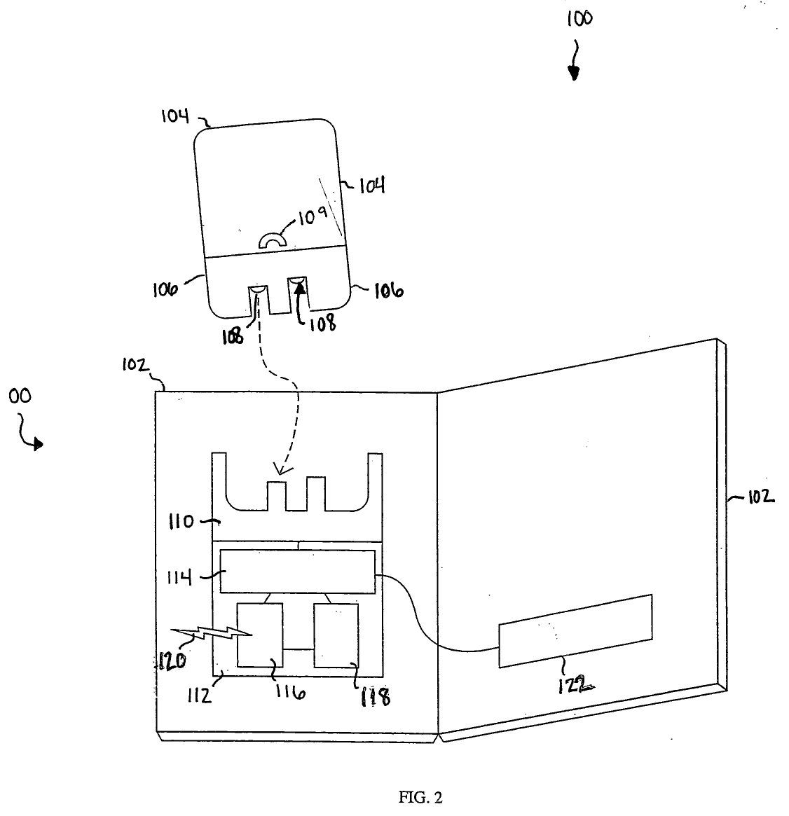

In the alternate embodiment of management system 100 shown in FIG. 2, a second microprocessor 122 is used in addition to the RF board processor 114 when additional processing power is required. One example of when this second microprocessor 122 would be utilized to manage complex polling routines that would check for data and to intelligently manage the transmission decision. This is a different function than what the RF board processor 114 is tasked to do, as it operates with minimal intelligence and simply reacts to inbound and simple outbound transmissions. To support a reasonable battery life for the unit, the user of the case 102 for the purpose of sending real-time data would prefer the second microprocessor option. This allows the additional processing power to intelligently manage the polling and transmission with the role of also optimizing the operation thus extending the battery life.

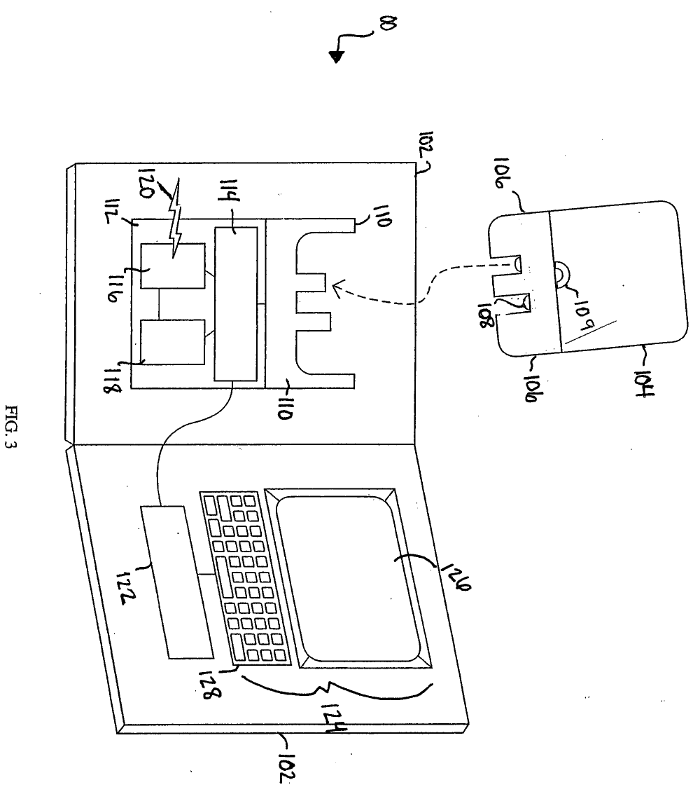

The alternate embodiment of FIG. 3 includes an optional user interface 124, which can be comprised of both an input technology 128 as well as an output technology 126, either combined as a single unit or separately as shown here.

In the preferred embodiment, the user interface output mechanism 128 would typically be a sensory unit that would be meaningful to one's senses including sight, hearing, etc. . . . This is typically an LCD type screen with text, symbols, colors or the like as well as audio of some kind.

In the preferred embodiment, the user interface input mechanism 126 would typically be a sensory unit that would be meaningful to one's actions and abilities including speech, typing, button depression, etc. . . . This is typically a keyboard, drawing screen, audio converter or recorder, specialized buttons with aggregated meanings (e.g.—consumption of small, medium or large meal which would have further definition elsewhere in the system).

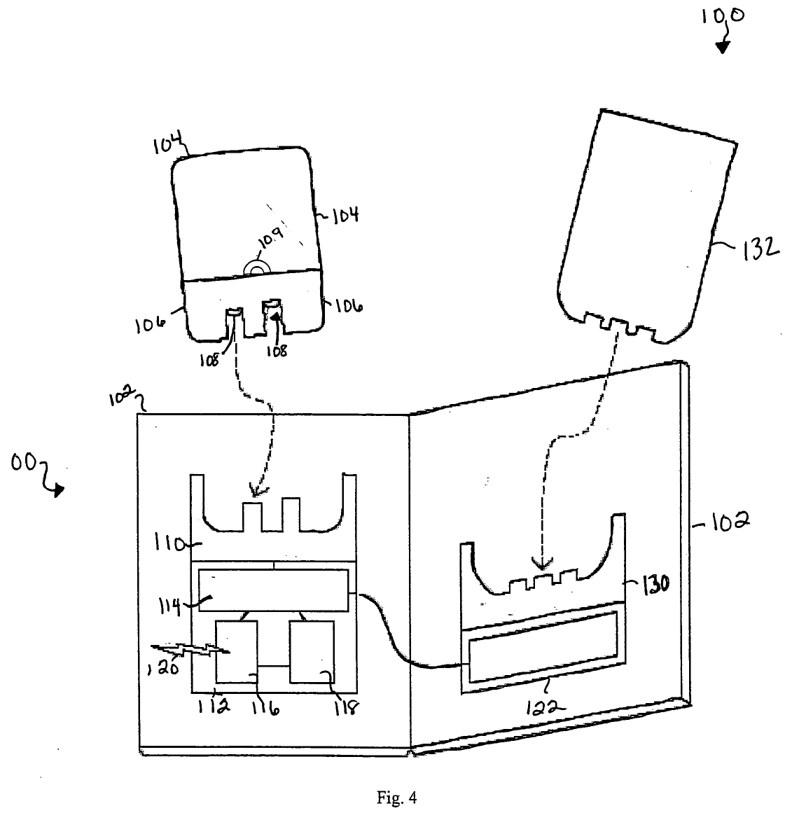

The embodiment of management system 100 shown in FIG. 4 includes a third set of interconnection plates 130 and 131, similar in function to plate 106 and to plate 110. This feature allows for the flexible yet planned integration of third party electronics 132 such as a personal digital assistants or micro/handheld computing devices. Such a device would contain its own user interface(s), microprocessor(s), power supply. However, by integrating through this planned docking station allows for the opportunity of shared services such as power recharging, processing power and the exchange of information, synchronization, programming, etc. . . . Third party electronic device 132 is a self-contained computing device such as a PDA, digital music player, etc . . . with significant data management application capabilities that one would use independent of the case and for purposes other than biometric diagnostics.

The communications connection plate 106, has a multitude of configurations necessary to provide for easy and logical placement and storage of an individuals preferred communications requirements. Electronics board 112 focuses on allowing a multitude of various third party communications modules including network specific communications boards. The preferred network type is of, or having to do, with radio or cellular transmission including any format or protocol. Examples of these wireless protocols are Reflex, Mobitex, GPRS, GSM, CDMA, and 802.11x of any format. Additional communications ports might include non-wireless means and specific physical requirements for communications via USB, Ethernet, IEEE 1394.x where x may equal any combination of letters or numbers, or any other present or future communications protocol and its physical connection requirements.

Management system 100 provides for several integration methods and physical ports designed for transparent technical and behavioral access to the biometric device data. In order to facilitate the notion of transparency and abstracting human dependencies from the act of data harvesting from the biometric devices, the following techniques and physical components are described that all relate back to the intelligent software housed on either of the aforementioned microprocessors. Since not all data-enabled biometric devices have the same requirements for data uploading by/to an external microprocessor, the intelligent software within management system 100 must have device specific preferences and rules for ensuring the most timely and accurate polling and appropriate biometric device-specific techniques without requiring a constant connection. In the preferred method the software will allow for the electrical sensing of changes in the electrical properties of the connection. Further, the software should allow for timing or chronological scheduling based on initial parameters set by the user and later driven by either human-designed intervals or, as a preferred method, automated timing intervals established by the software's historical view toward the presence of new device data. This is yet another actualization of the intelligent software abstracting human intervention and dependency.

Device and location specific, spring-loaded plates 104, 106 are yet another mechanism that can provide a passive, intelligent mechanism to understand that a device has been both removed from the case as well as replaced into its dedicated location within the case. Again, the intelligent software can be designed with device specific routines and rules that take this in/out awareness into account when determining the appropriate time to poll the respective device for new data. Human intervention in the form of depressing a button or any other simple technique for invoking the device polling function. Transmission and other data management functions would be automatic past that initial point of human intervention.

In the preferred embodiment of the invention, there is intentionally no user interface on management system 100 for enabling human intervention. An example of “user interface” would be an LCD screen or computer-generated speech for facilitating one-way communications as well as the preceding plus a communications input mechanism such as a text keyboard or audio recorder for facilitating two-way communications. This is done in order to: eliminate human error; reduce support costs that come with more complex, interactive wireless devices; lower the cost of manufacturing the device; and reduce the likelihood of theft by severely limiting the role and perceived value only to those familiar with the exact purpose and function of the device. An exception to this would be simple indicators for indicating successful transmission or function completion such as audio tones, temporary visual lighting nodules (e.g. LED indicators of green, red, yellow, etc . . . ).

In the embodiment of the invention shown in FIG. 3, user interface 124 can be a priority function of the device. However, it is very important to distinguish the importance the health management case 100 both with and without the characteristics that come with the user interface functionality. User interface 124 is a premium feature geared only toward those with a mind toward aggressive disease management. This notion of a user interface can range from case-specific LCD screens and an embedded text input keyboard, to a docking station for a text input device either with or without external communications capabilities, to a fully functioning personal digital assistant which would require an accompanying docking station for the computing device in the context of the aforementioned device connection plate 104, the device connection plate. The implementation of this docking data port may be as described within device connection plate 104 or as a separate, plate 130 (FIG. 4) designed as a docking station for third party computing and communications device as in the case of the PDA or Cell Phone or other textual and communications device.

Remote communications of the biometric device data 104 is passively and intelligently transmitted to a remote computer, in system 200, server 201. In the preferred embodiment, this communication uses a third party's private wireless network however any means of transport is relevant to the data transmission.

Software intelligence to govern the data access and data management may reside both onboard either of the case-local microprocessors or on board any number of remote computers. A combination of user defined and computer-derived rules govern the flow of data and translation into information. This subsequent information may be processed and reside either together or apart both locally and remotely or in any combination thereof. Preferably, server 201 supports an automatic risk-based population stratification scheme which allows a caregiver an “at-a-glance” evaluation of a patent practice encompassing a large number of patients. The system (server) software algorithms will determine optimization in terms of the location-specific processing limitations, usage requirements and transmission costs as it relates to the appropriate sharing of data and information keeping in mind the managed cost limitations of the system. The system also includes specialized tools for providing easy analysis for any number of patient's disease state and to facilitate the analysis, determination and recommendation of lifestyle changes to a prescribed or actual disease management protocol.

Therefore, due to the nature of the invention, time is managed separately within the many disparate subsystems within the overall system 200. First, time may be managed within any invasive bio-implant, then within any short range external bio-implant communication system, again, within an external biometric device, then within the proposed invention acting as the remote telemetry communications module, again within a handheld computer used by the subject, again within a circuit-switched communications device, again within the initial wireless base station network element of the wide area wireless network, again within the various gateway computers managed by the operator of the wide area wireless network, again within the gateway computers managed by the remote biometric device and invasive bioimplant monitoring system computers, as well as a myriad of additional keepers of time. What is critical is the availability of relevant data from the myriad keeper's of time and the logic to discern the “best” indication of time. This is especially critical when one chronic disease patient crosses time zones and therefore due to lifestyle modifications imposed by one who participates in society, behavior changes accordingly. This is obvious when one considers meal times and the associated intake of carbohydrates that will affect the physiology of the chronic disease patient as well as the prescription regimen for pharmaceutical or natural drugs used in managing the chronic disease.

One such tool is known as the “Triage Plot.” This graphical depiction allows any user to easily identify a group subset as being in any number of tiered chronic conditions relative to a standard or to the peer group being included in the analysis. The physician's practice must have this capability to quickly identify, at-a-glance, those patients in a chronic state or trending toward a chronic state using a multitude of discriminating parameters. Likewise, it is essential that the user of the tool be able to dynamically modify their parameters used to identify the chronic pool, easily, within a single session of the remote analysis. An example of these parameters may be the establishment of a patients historical blood glucose average over some defined period of time. This average should be normalized prior to plotting as the user pool come from a large group of patients all of whom have their own unique definitions of “Normal,” “High”, and “Low”.” Normalization can be obtained by plotting the average as a percent within the patient-specific range for the appropriate categorization of low, normal, high. This normalization can be performed for all subjects identified within the patient-comparison or patient-relevant groupings. These groupings may be defined by the user as all patients within a given practice, all similarly aged patients within a population, basically, an infinite number of parameterizations. This data point can then be plotted on one of the axis. An example use for the other axis may be a measure of resource utilization captured by the user of the Triage Plot. One such parameter can be the number of calls logged by the physician's office or some other measure of a patient's specific resource utilization. These two data points would then determine the location of the Plotted patient and would indicate the relationship between relative chronic disease state and office resource utilization. Once this plotting is completed for the group of selected individuals, the user of the tool has an easily understandable chart of information that indicates the priority patients for proactive disease management. Since the information is obtained in a timely fashion, physicians and their staff now have the opportunity to exercise Proactive patient disease management instead of Reactive patient disease management. There are an infinite number of parameters and uses for this plotting mechanism. What is claimed specifically is the method for promoting the visual segmentation of a population so as to enable the user of the information management tool to make quick decisions based on timely information across a diverse set of data sources and to be able to act on this information in a manner consistent with the objectives of parameter selection. In the example, the objective is to increase resource utilization by prioritizing chronic patients relative to both their high resource utilization as well as a lack or inappropriately low resource utilization.

Yet another aspect of this system is the design toward accessing third party developed and managed algorithms for predictive disease management as well as making the stored data available to such third party predictive disease management algorithms. It is not possible for a limited number of resources or individuals to develop the analysis equations that would produce the most accurate feedback recommendations for something as varied and diverse as the management of diabetes. Therefore, it is only through establishment of a data and information clearinghouse with actual meta-data that the scientific community can have access first to testing various hypothesis and to subsequently place into a reliable automated communications role, the proven and reliable advice for promoting self-management through automated recommendations for lifestyle changes.

As part of the function of creating a clearinghouse of diabetes relevant data, it must be understood that a large population of diabetics and their care teams will always have diverse requirements and preferences when it comes to their preferred tools. As such, it is important to allow for personal tool selection and to also provide a non-intrusive mechanism for harvesting the data and subsequent patient-defined information and to make this data/information available to the aforementioned clearinghouse of meta-data. It is through the clearinghouse that peer group analysis can easily take place whether this is by a physician's office, a medical research team, or simply a collaborative group of patients who wish to share and compare their data and information. This aspect of the system provides for that level of abstraction between personally selected and utilized day-to-day tools and the ability for a community to take advantage of the experience of its respective members. This design is actualized in this area of diabetes management and other disease management groups by allowing for a software agent that can be either co-located with the any number of an individual's third party data management applications or positioned remotely providing reliable remote communications and access to the third party diabetes data management application. This communication can be either a one-way harvesting of the data/information or can be a synchronized two-way function providing that the developer of the third party localized diabetes data management application is able to function with the receipt and subsequent data handling requirements of the non-patient specific or enhanced information from the meta-data clearinghouse.

The embodiments and examples set forth herein are presented to best explain the present invention and its practical application and to thereby enable those skilled in the art to make and utilize the invention. Those skilled in the art, however, will recognize that the forgoing description and examples have been presented for the purpose of illustration and example only. Other variations and modifications of the present invention will be apparent to those of skill in the art. The description as set forth is not intended to be exhaustive to limit the scope of the invention. It is contemplated that the use of the present invention can involve components having different characteristics.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A network comprising:
a server for receiving and collecting biometrics information from a mobile unit and distributing said information to a health care team member;
a mobile unit for interfacing with a biometric device and transmitting the biometric information from the biometric device to the server without modifying the patient's behaviour.

2. The network of claim 1, wherein the biometric device timekeeping mechanism is managed by the mobile device.

3. The network of claim 1, wherein the server implements an automated risk-based population stratification process.
